(19) United States
(12) Patent Application Publication
(10) Pub. No.: US 2019/0080170 A1
(43) Pub. Date: Mar. 14, 2019

(54) ICON-IZE IDENTIFIED OBJECTS IN A KNOWN AREA TO ADD MORE CONTEXT TO 3D COMPUTER VISION

(71) Applicant: Intel Corporation, Santa Clara, CA (US)

(72) Inventors: Jim S. Baca, Corrales, NM (US); Andrew J. Kuzma, Portland, OR (US); Yuenian Yang, Granite Bay, CA (US); Prital B. Shah, Chandler, AZ (US); Mark H. Price, Placitas, NM (US); Sabarish Raghu, Chandler, AZ (US); David Stanasolovich, Phoenix, AZ (US)

(21) Appl. No.: 15/704,055

(22) Filed: Sep. 14, 2017

(51) Int. Cl. G06K 9/00; G06T 11/60

(52) U.S. Cl. CPC G06K 9/00671; G06T 11/60; G06K 9/00201

(57) ABSTRACT

Systems, apparatuses and methods iconize identified objects in a known area to add personalized context to 2D and 3D computer vision (CV) via metadata. CV enabled devices (e.g., mobile devices, robots, drones, AR, etc.) will be able to utilize the additional context tagged on each recognized object to discern between objects and take action.

### TECHNICAL FIELD

Embodiments generally relate to computer vision (CV) object recognition and, more particularly, to associating icons with real world objects to avoid having to re-recognize the object each time its encountered.

### BACKGROUND

Computer vision (CV) solutions using two-dimensional (2D) and three-dimensional (3D) cameras, software and analytics allow for object recognition. However, each time an object comes into the camera's field of view, the camera and supporting software analytics may re-recognize and re-learn that there is an object in the field of view (FOV) and then re-recognize the object. Further, there may be no context provided with the object.

### BRIEF DESCRIPTION OF THE DRAWINGS

The various advantages of the embodiments will become apparent to one skilled in the art by reading the following specification and appended claims, and by referencing the following drawings, in which:

FIG. 1A is a living room scene illustrating various items such as furniture and decorations that may be present;

FIG. 1B is the living room of FIG. 1A having been previously mapped and icons with unique metadata pertaining to the items superimposed over the item or representing the item;

FIG. 2 is an example of an abstraction map including the living room of FIG. 1B also including mapping of other rooms and outdoor space;

FIG. 3 is a block diagram of an exemplary computer system which may be part of a robot, tablet, phone, laptop, goggles, etc. suitable for carrying out embodiments; and

FIG. 4 is a flow diagram illustrating one use case for one embodiment.

### DESCRIPTION OF EMBODIMENTS

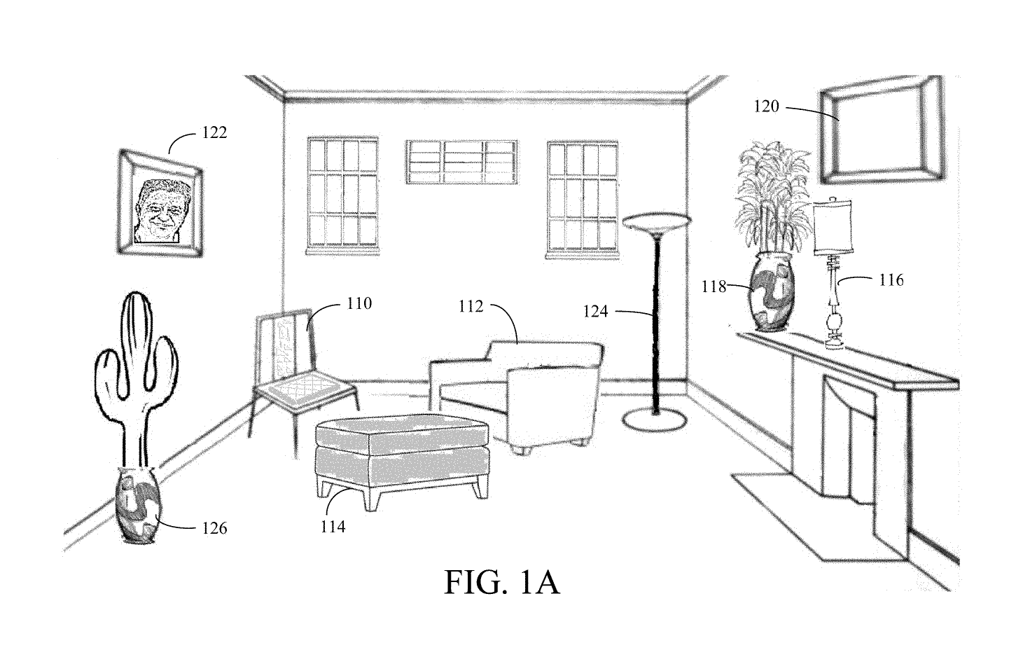

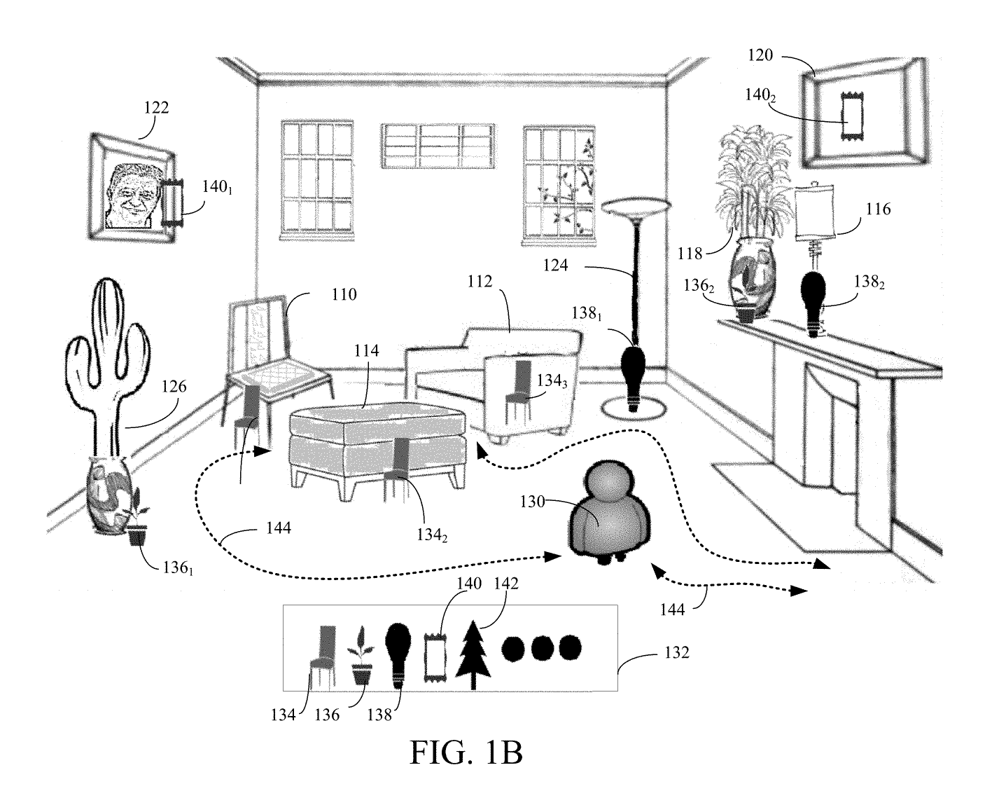

Turning now to FIGS. 1A-1B, to avoid re-recognizing an object each time it may be encountered, the object may be associated with an icon or “iconized” and metadata specific to the object may also be captured. The metadata may include information including, but not limited to, the location of the object.

FIG. 1A shows an example of a room in a house containing objects that may be found in an ordinary living room. As shown, the room may contain a furniture including a wooden chair 110, an upholstered chair 112, and an ottoman 114, a table lamp 116 and a potted plant 118 sitting on a fireplace mantel. The room may also include a framed mirror 120, a framed picture 122, a floor lamp 124, and a potted cactus 126. A robot, drone, smart phone, or other smart device (not shown) may have to re-recognize these objects when it enters a room, or may have to store massive amounts of data somewhere to keep the many rooms and places that it has previously encountered at the ready.

FIG. 1B shows the same room as FIG. 1A except a smart device, in this case a robot 130, has previously mapped out the room and iconized a map of many of the objects in the room.

An icon library 132 may be provided comprising icons to represent various common objects. For illustrative purposes, the library shown comprises a chair icon 134, a plant icon 136, a light bulb icon 136, a frame icon 138, and a tree icon 142. Of course, this list is non-exhaustive as there may be many other icons or icons of different levels of abstraction. For example, the plant icon 136 and the tree icon 142 may be replaced by just the plant icon 136 since they are both vegetation.

Embodiments are directed to a method and apparatus to iconize identified objects in a known area to add context to 2D and 3D computer vision via metadata. Embodiments not only recognize objects in a scanned/learned area (e.g., with a GOOGLE TANGO device), but match recognized items with icons. Initially the system may ask the user to select a best fit icon, after a learning period icons and items may be automatically matched. These icons may be superimposed or tagged over the objects each time the computer enable device returns to a known area. These icons metadata may include:

Basic info about a chair (e.g., location, wooden, stuffed, etc.), specifics about the object (e.g., no cushion or plaid cushion) each time the CV enabled device sees the object. The user may also manually add context (e.g., soft or hard wood chair with plaid cushion, family heirloom from Uncle Jim, etc.). All of the metadata about an item may be stored in a memory with the icon.

Still referring to FIG. 1B, the robot 130 has previously mapped out this living room and matched icons with the various items as well as mapped a path or paths 144. Rather than a robot 130, if a person was walking around with a tablet or a head mounted display (e.g., virtual reality/VR or augmented reality/AR goggles), the person would see the icons superimposed over the actual items or may just see the icons.

The chairs 110, 112 and ottoman 114 have all been superimposed with a chair icon 134₁₋₃, respectively, because all of them may be sat upon. The metadata associated with each of the chair icons 134₁₋₃ will be unique to the item with which it is matched. For example, chair icon 134₂ may have metadata including red, leather, ottoman, location, perhaps even date purchased and receipt information.

Likewise, the framed wall portrait 122 and framed mirror 120 may be superimposed with frame icons 138₁₋₂, and lamps 124 and 116 superimposed with lightbulb icons 138₁₋₂.

Similarly, a plant icon 136₁ and 136₂ may be superimposed over the cactus 126 and the palm 118. The metadata associated with these icons may, in addition to including location in the room, may also include information about the type of plant and care instructions such as watering schedule and further keep track of the last time watered and the next time needing water for automatic watering by the robot 130.

These icons and associated metadata may easily be transferred from one device to another or shared to the cloud or even locally via Bluetooth, etc. Further, when the metadata is shared to the cloud and the user opts-in, advertisers can recommend complementary or even replacement goods and provide coupons/price reductions towards the purchase. For example, the robot may notice a cushion on chair 110 is worn and offer a replacement or a coupon for a furniture cleaning service.

Embodiments provide a method and apparatus to iconize identified objects in a known area to add personalized context to 2D and 3D computer vision via metadata. CV enabled devices (e.g., mobile devices, robots, drones, AR, etc.) will be able to utilize the additional context tagged on each recognized object to discern between objects and take action (e.g. robot, please bring me a wooden chair with plaid cushion). Additionally, pre-created machine-learning/neural-network models, or even sets of models, containing the appropriate data/tests, may be downloaded from the cloud to allow iconization of objects that have never been previously scanned by the local system.

This capability may be used as a query for inventory. No need for detail, just a quick list with basic information (e.g. the number of chairs and the rooms they are in, number of lights in the house including how many of them are on, how many are burnt out and the locations on the map as designate icons).

Another scenario comprises a big store. In order to replenish groceries a robot can learn different fruits and vegetables and tag them. In the night it can go around the aisles, see what items are low and replenish them. Yet another possible scenario is location tagging of an area based on human activity recognition. The robot can use deep learning algorithms that recognize human activities (e.g. working/playing basketball/reading book/eating etc.) and share them with other robots via the cloud. If the robot receives information as to these types of human activities from the cloud, it can inform and lead its user to the correct location when queried. For example, “Find nearest place where I can play basketball”.

Also, successfully navigating through spaces often requires maps with different levels of abstraction appropriate to the tasks and goals. For instance, in the treasure map shown below, the “hills” do not need to be rendered in a topological manner to understand the gist of the path, and it is sufficient to use iconized graphics to represent trees and forests. Adding a compass rose which is not part of the real scene, adds additional orientation information.

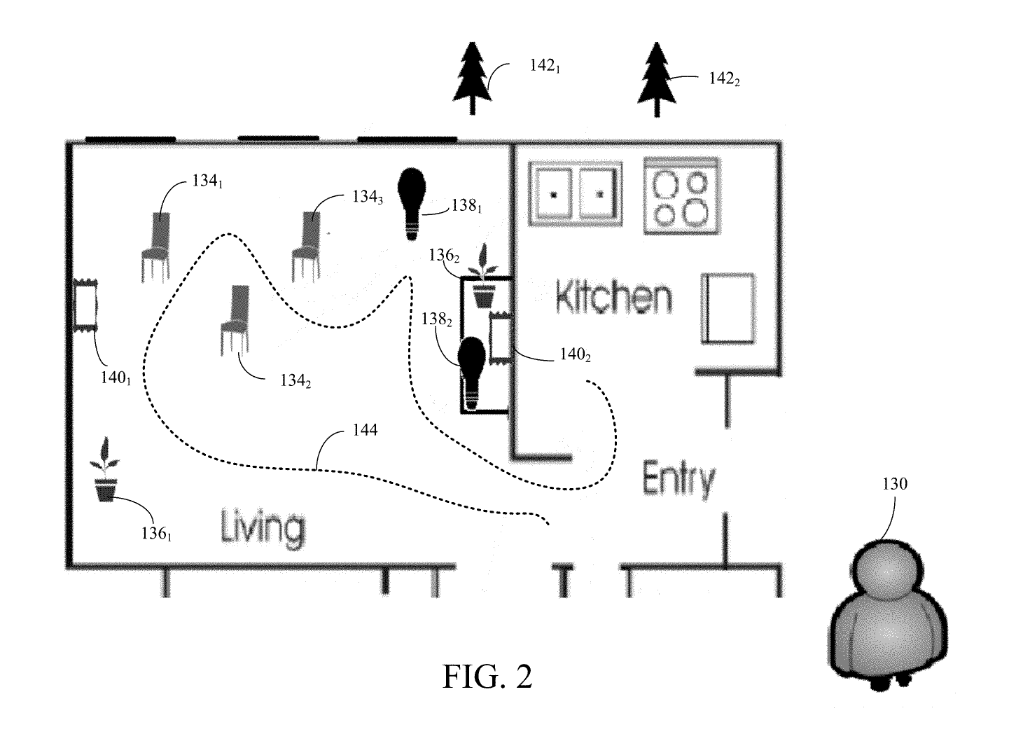

Referring now to FIG. 2, there is shown an example of abstraction map for a house, including the living room shown in FIGS. 1A-1B. Like icons are similarly labeled and not repeated to avoid repetition. In the map, the actual items are simply represented by their respective icons. In addition, the backyard may also be mapped to include tree icons 142₁₋₂.

By abstracting to an iconized representation rather than a more literal point-cloud or mesh-vertex view, we get a navigation map which is more succinct (and smaller memory footprint) while being sufficient for many tasks. The same object detection algorithm allows us to associate the abstract icon to a more detailed description of the object, including the relevant segmented point-could data constructed during a 3D scan, or even the 3D vertex-mesh from which the object may have been originally detected. Alternatively, pre-created machine-learning/neural-network models, or even sets of models, containing the appropriate data/tests may be downloaded from the cloud to allow iconization of objects that have never been previously scanned by the local system. This could be particularly useful for common objects in specific domains (e.g., home, warehouse, supermarket, etc.).

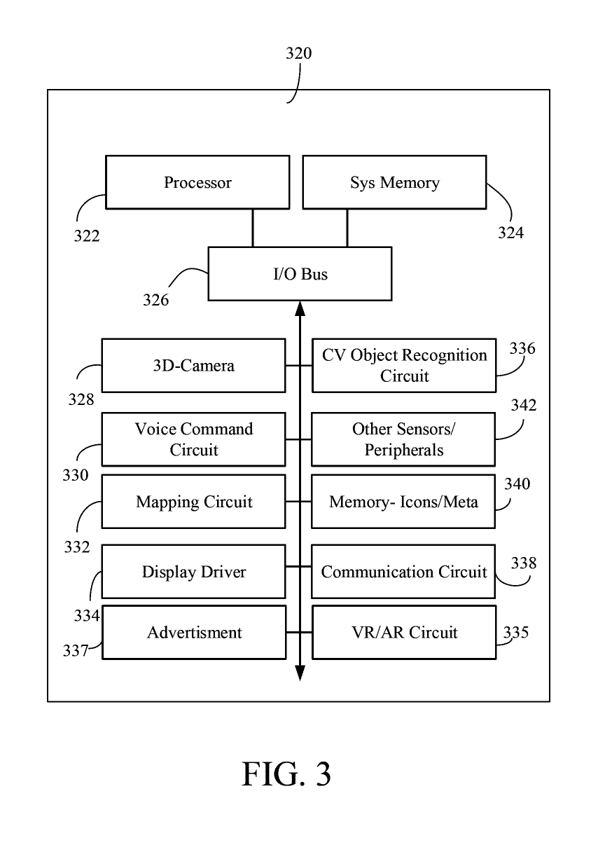

FIG. 3 shows an example block diagram of a computing system 320 for carrying out embodiments. The system 320 may include a processor 322, a persistent system memory 324, and an Input/output (I/O) bus 326 connecting the processor 322 and memory 324 to other circuits in the system. These may include, a 3D camera 338 and associated CV software to recognize objects 336, a voice command circuit 330 for giving commands and manually entering metadata about a particular item, display driver 334, a virtual reality (VR)/augmented reality (AR) circuit for superimposing icons on real world items 335, mapping circuit 332 for navigation, a communications circuit 338, a data storage memory circuit 340 for storing icons with associated metadata, as well as other sensors and peripherals 342.

Embodiments of each of the above system components may be implemented in hardware, software, or any suitable combination thereof. For example, hardware implementations may include configurable logic such as, for example, programmable logic arrays (PLAs), FPGAs, complex programmable logic devices (CPLDs), or in fixed-functionality logic hardware using circuit technology such as, for example, ASIC, complementary metal oxide semiconductor (CMOS) or transistor-transistor logic (TTL) technology, or any combination thereof. Alternatively, or additionally, these components may be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system applicable/appropriate programming languages, including an object-oriented programming language such as PYTHON, PERL, JAVA, SMALLTALK, C++, C# or the like and conventional procedural programming languages, such as the “C” programming language or similar programming languages.

The 3D camera 328 may be an INTEL REALSENSE 3D camera. Additionally, in some embodiments, the camera 328 may be embodied as a 2D camera coupled with appropriate image processing software to generate a depth image based on one or more 2D images.

Use Case 1: Stanley is an autonomous robot that lives in the home of his user, Andy. Andy purchased him to help with some basic chores around the house. Stanley is equipped with both 2D and 3D cameras and software analytics (both local and in the cloud) that provide some basic computer vision capabilities starting with the ability to scan and learn an area and to identify objects in the house. He has already scanned the area and knows it and the objects stored in the area. Being a good/efficient robot, he has utilized the ability to tag each object in the area with an icon and has updated the metadata for each every time he got the chance. Andy would like to change a light bulb in the den and needs a wooden chair with no cushion to stand on. Rather than lug the chair over himself, he asks Stanley to fetch the desired chair. Stanley quickly assesses his object icons to determine where the closest wooden chair with no cushions is located in the home and determines it is in the living room. He fetches the object and Andy is able to change the lightbulb.

Use Case 2: Jim has purchased Stanley from Andy, and wants Stanley to clean up the garage. Stanley has never been to Jim's house and does not know that Jim's garage is detached from the main house. However, Rose, Jim's other robot, does have an iconized map of the property that includes the garage. When Jim asks Stanley to head to the garage, Stanley asks Rose “What does Jim mean by ‘garage’?”. Rose is able to associate the language term “garage” to an area on her map, so she shares this map with Stanley. Stanley is now has sufficient information about his relative position and a description of critical waypoints that he can successfully navigate to the garage without tripping down the back steps and can open the picket gate along the path rather than trampling on the flower bed.

Use Case 3: Prital is a robot who has been sent to a large grocery store to pick up a few items for her user's home. She is in the store and has her list of items pulled up. Because she can learn and discern between different fruits and vegetables, she can tag them and even though it is night time and the store is closed (she has special permissions to enter) can search the aisles and find the best deals and purchase them. Because she knows what a tomato is and where in the store she found it (saved info as an icon in the area), next time she returns to the store she can easily locate the tomatoes and purchase them again. If she would not have stored this info as metadata in an icon, she would have to relocate the tomato every time she went shopping. Also, since the store expects Prital and knows what she is going to purchase each week, the store can present coupons/deals to her to entice her to choose their store again.

Use Case 4: Doug has an autonomous robot named Juan. Juan has developed an extensive iconized map of the Doug's house, along with the specific characteristics of each of the family members' rooms. For example, an iconized map of Doug's 15 year old daughter, has certain areas and objects which the robot can clean and help organize, which are different from Doug's 12 year old son. Doug leases another robot from a service to provide personalized service for his daughter. The iconized map and associated context knowledge tree for Doug's house are transferred from Juan, however Doug wants to ensure that the leased robot only has access to knowledge about his daughter's room. Before transferring the iconized information from Juan to the new robot, Doug locks out those portions of the iconized map which do not refer to his daughter's room. If at a later time, Doug wants to use this robot for his family, he can enter the strong password and open the complete iconized map and contextual knowledge tree to the new robot.

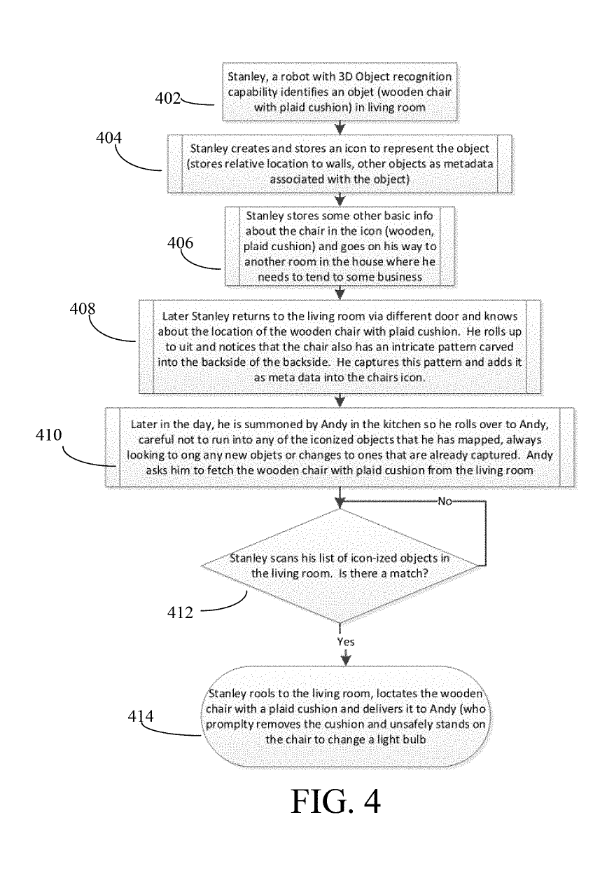

Use Case 5: Referring to FIG. 4, At box 402, “Stanley,” a robot with 3D Object recognition capability identifies an object (wooden chair with plaid cushion) in living room.

At box 404, Stanley creates and stores an icon to represent the object (stores relative location to walls, other objects as metadata associated with the object).

At box 406, Stanley stores some other basic info about the chair in the icon (wooden, plaid cushion) and goes on his way to another room in the house where he needs to tend to some business.

At box 408, later Stanley returns to the living room via different door and knows about the location of the wooden chair with plaid cushion. He rolls up to it and notices that the chair also has an intricate pattern carved into the backside of the backside. He captures this pattern and adds it as metadata into the chair's icon.

At box 410, later in the day, he is summoned by Andy in the kitchen so he rolls over to Andy, careful not to run into any of the iconized objects that he has mapped, always looking to on any new objects or changes to ones that are already captured. Andy asks him to fetch the wooden chair with plaid cushion from the living room.

At decision box 412, Stanley scans his list of icon-ized objects in the living room. Is there a match?

At box 414, Stanley rolls to the living room, locates the wooden chair with a plaid cushion and delivers it to Andy (who promptly removes the cushion and unsafely stands on the chair to change a lightbulb.

### ADDITIONAL NOTES AND EXAMPLES

Example 1 may include an apparatus to identify objects in a mapped area as icons comprising, a processor communicatively connected to a persistent memory, a camera and associated computer vision (CV) circuitry to recognize objects, an icon library comprising a plurality of stored icons to represent recognized objects, and metadata associated to each icon stored in the memory, the metadata comprising location and at least one other item specific to the object represented by the icon.

Example 2 may include the apparatus as recited in example 1, further comprising, a display communicatively coupled to the processor, and augment reality (AR) circuitry to display the icons superimposed on the object they represent.

Example 3 may include the apparatus as recited in example 2, wherein the metadata comprises care instructions and schedules specific to the object represented by the icon.

Example 4 may include the apparatus as recited in example 1 further comprising mapping circuitry to create and store an abstraction map of an area where objects are represented by their location and icon.

Example 5 may include 5 the apparatus as recited in example 4 wherein the abstraction map to be communicated to another device.

Example 6 may include the apparatus as recited in example 1 further comprising voice command circuitry to manually add metadata to an icon.

Example 7 may include a method to identify objects in a mapped area as icons, comprising, moving throughout an area to be mapped, identifying objects in the area with computer vision (CV) circuitry, storing in a memory an icon to represent identified objects, and storing metadata with each icon, the metadata comprising at least location and at least one other item specific to the object represented by the icon.

Example 8 may include the method as recited in example 7, further comprising, displaying the icons representing identified objects superimposed on the object represented.

Example 9 may include the method as recited in example 7 further comprising, creating an abstraction map of the area using the icons in place of objects represented by the icons.

Example 10 may include the method as recited in example 9 further comprising, communicating the abstraction map to another device.

Example 11 may include the method as recited in example 9, wherein the metadata further comprises care instructions and schedules specific to the objects represented by the icons.

Example 12 may include the method of example 9 further comprising, communicating icons and metadata to advertisers, and receiving commercial advertisements for the objects represented by the icons.

Example 13 may include at least one computer readable storage medium comprising a set of instructions which, when executed by a computing device, cause the computing device to perform the method of any one of examples 7-12.

Example 14 may include a system to identify objects in a mapped area as icons, comprising, a first device comprising, a processor communicatively connected to a persistent memory, communication circuitry communicatively coupled to the processor, a camera and associated computer vision (CV) circuitry to recognize objects, an icon library comprising a plurality of stored icons to represent recognized objects in a mapped area, and metadata associated to each icon stored in the memory, the metadata comprising location and at least one other item specific to the object represented by the icon, and a second device to receive the icons and metadata associated to each icon.

Example 15 may include a system as recited in example 14 wherein the second device to navigate through the mapped area using the icons and metadata associated to each icon.

Example 16 may include the system as recited in example 14 wherein the second device is located remotely and the first device receives data related to the icons and metadata associated to each icon.

Example 17 may include an apparatus to identify objects in a mapped area as icons, comprising, means for moving throughout an area to be mapped, means for identifying objects in the area with computer vision (CV) circuitry, means for storing in a memory an icon to represent identified objects, and means for storing metadata with each icon, the metadata comprising at least location and at least one other item specific to the object represented by the icon.

Example 18 may include the apparatus as recited in example 17, further comprising, means for displaying the icons representing identified objects superimposed on the object represented.

Example 19 may include the apparatus as recited in example 17 further comprising, means for creating an abstraction map of the area using the icons in place of objects represented by the icons.

Example 20 may include the apparatus as recited in example 19 further comprising, means for communicating the abstraction map to another device.

Example 21 may include the apparatus as recited in example 17, wherein the metadata further comprises care instructions and schedules specific to the objects represented by the icons.

Example 22 may include the apparatus of example 17 further comprising, means for communicating icons and metadata to advertisers, and means for receiving commercial advertisements for the objects represented by the icons.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1. An apparatus comprising:
a processor communicatively connected to a persistent memory;
a camera and associated computer vision (CV) circuitry to recognize objects;
an icon library comprising a plurality of stored icons to represent recognized objects;
metadata associated to each icon stored in the memory, the metadata comprising location and at least one other item specific to the object represented by the icon; and
mapping circuitry to create and store an abstraction map of an area with the icons in place of objects represented by the icons.

2. The apparatus as recited in claim 1, further comprising:
a display communicatively coupled to the processor; and
augment reality (AR) circuitry to display the icons superimposed on the object they represent.

3. The apparatus as recited in claim 2, wherein the metadata comprises care instructions and schedules specific to the object represented by the icon.

4. (canceled)

5. The apparatus as recited in claim 4 wherein the abstraction map to be communicated to another device.

6. The apparatus as recited in claim 1 further comprising voice command circuitry to manually add metadata to an icon.

7. A method, comprising:
moving throughout an area to be mapped;
identifying objects in the area with computer vision (CV) circuitry;
storing in a memory an icon to represent identified objects;
storing metadata with each icon, the metadata comprising at least location and at least one other item specific to the object represented by the icon; and
creating an abstraction map of the area using the icons in place of objects represented by the icons.

8. The method as recited in claim 7, further comprising:
displaying the icons representing identified objects superimposed on the object represented.

9. (canceled)

10. The method as recited in claim 7 further comprising:
communicating the abstraction map to another device.

11. The method as recited in claim 7, wherein the metadata further comprises care instructions and schedules specific to the objects represented by the icons.

12. The method of claim 7 further comprising:
communicating icons and metadata to advertisers; and
receiving commercial advertisements for the objects represented by the icons.

13. At least one computer readable storage medium comprising a set of instructions which, when executed by a computing device, cause the computing device to:
move throughout an area to be mapped;
identify objects in the area with computer vision (CV) circuitry;
store in a memory an icon to represent identified objects;
store metadata with each icon, the metadata comprising at least location and at least one other item specific to the object represented by the icon; and
create an abstract map of the area using the icons in place of objects represented by the icons.

14. The medium as recited in claim 13, further comprising:
displaying the icons representing identified objects superimposed on the object represented.

15. (canceled)

16. The medium as recited in claim 13 further comprising:
communicating the abstraction map to another device.

17. The medium as recited in claim 13, wherein the metadata further comprises care instructions and schedules specific to the objects represented by the icons.

18. The medium as recited in claim 13, further comprising:
communicating icons and metadata to advertisers; and
receiving commercial advertisements for the objects represented by the icons.

19. A system comprising:
a first device comprising:
a processor communicatively connected to a persistent memory;
communication circuitry communicatively coupled to the processor;
a camera and associated computer vision (CV) circuitry to recognize objects;
an icon library comprising a plurality of stored icons to represent recognized objects in a mapped area; and
metadata associated to each icon stored in the memory, the metadata comprising location and at least one other item specific to the object represented by the icon;
mapping circuitry to create and store an abstraction map of an area with the icons in place of objects represented by the icons; and
a second device to receive the abstraction map.

20. A system as recited in claim 19 wherein the second device to navigate through the mapped area using the icons and metadata associated to each icon.

21. The system as recited in claim 19 wherein the second device is located remotely and the first device receives data related to the icons and metadata associated to each icon.
